(19) United States
(12) Patent Application Publication
(10) Pub. No.: US 2016/0041982 A1
(43) Pub. Date: Feb. 11, 2016

(54) Conditioned Search Ranking Models on Online Social Networks

(71) Applicant: Facebook, Inc., Menlo Park, CA (US)

(72) Inventors: Junfeng He, Fremont, CA (US); Cristina Scheau, Menlo Park, CA (US); Rajat Raina, Mountain View, CA (US); Maxime Boucher, Mountain View, CA (US); Xiao Li, Sunnyvale, CA (US)

(21) Appl. No.: 14/452,307

(22) Filed: Aug. 5, 2014

(51) Int. Cl. G06F 17/30

(52) U.S. Cl. CPC G06F 17/3053; G06F 17/30867

(57) ABSTRACT

In one embodiment, a method includes a computing system receiving a query from a first user, which can be parsed to identify i conditions associated with the query. The system may then identify one or more search results substantially matching the i conditions. Each search result may be associated with a feature vector of j features. The system may then access a conditioned ranking model that comprises j scoring functions for each i condition. The j scoring functions may correspond to j features of the feature vectors. A score for each search result may be calculated based on the i conditions and the j features. The system may then receive a selection of one of the search results from the first user, and in response modify one or more of the j scoring functions of the conditioned ranking model based on the selection.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, a social-networking system may receive a query from a user of an online social network hosted by the social-networking system. In response to the user's query, the social-networking system may parse the received query to identify a set of i conditions associated with the received query. As an example and not by way of limitation, for a search query related to “photos of me in [location],” the conditions that may be associated with the search query are “photos of [user]” and “photos in [location].” The social-networking system may also identify one or more search results substantially matching the i conditions associated with the received query. Furthermore, each search result may be associated with a feature vector [symbol] of j features. Different features may be associated with different types of search query content. As an example and not by way of limitation, a search query content related to users of the social-networking system may have features related to demographics data, friends, and followers. As another example and not by way of limitation, a search query content related to photos may have features associated with likes, tags, and comments. The j features may include information about the user, the query, or about the social graph. The social-networking system may access a conditioned ranking model. The conditioned ranking model may include j scoring functions corresponding to j features of the feature vector ( [symbol] ) associated with each search result for each i condition. Each j scoring function may be based on the search scenario (for example, a user search versus photo search). Furthermore, the conditioned ranking model may include a linear ranking algorithm for determining a rank of each search result. The linear ranking algorithm may evaluate each search result by summing the feature scores determined by the scoring functions for all i conditions and j features of the search result. As an example and not by way of limitation, a score s for a search query result may be represented by s=Σ_{iεconditions}Σ_{jεfeatures}Rᵢⱼ(fⱼ) where Rᵢⱼ(fⱼ) corresponds to a particular feature score of the j features and i conditions. The social-networking system may calculate a score for each search result based at least in part on the i conditions and the j features as associated with each i condition. In particular embodiments, the social-networking system may present a pre-determined selection of the scored search results to the first user. In response to a selection of one of the search results from the first user, the social-networking system may modify one or more of the j scoring functions and the linear ranking algorithm associated with the conditioned ranking model based at least in part on the selected search result by the first user. In particular embodiments, the modification may be based on a machine-learning algorithm.

The embodiments disclosed above are only examples, and the scope of this disclosure is not limited to them. Particular embodiments may include all, some, or none of the components, elements, features, functions, operations, or steps of the embodiments disclosed above.

### BRIEF DESCRIPTION OF THE DRAWINGS

FIG. 1 illustrates an example network environment associated with a social-networking system.

FIG. 2 illustrates an example social graph.

FIG. 3 illustrates an example set of i conditions identified in response to a query.

FIG. 4 illustrates an example set of seven conditions identified in response to a query.

FIG. 5 illustrates example scoring functions.

FIG. 6 illustrates an example tree data structure for implementing a conditioned ranking model.

FIG. 7 illustrates an example method for training scoring functions.

FIG. 8 illustrates an example computer system.

### DESCRIPTION OF EXAMPLE EMBODIMENTS

### System Overview

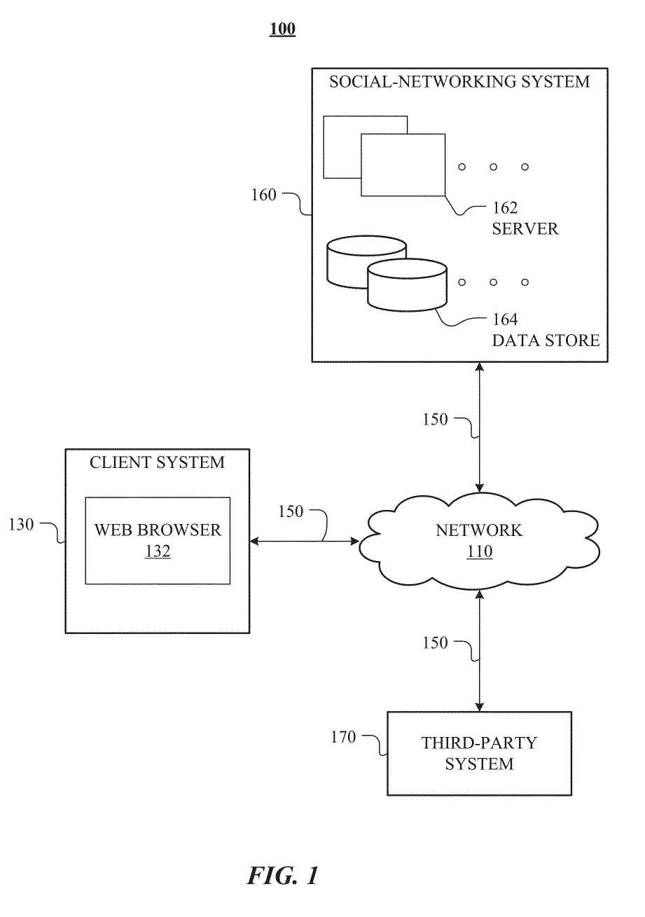

FIG. 1 illustrates an example network environment 100 associated with a social-networking system. Network environment 100 includes client system 130, social-networking system 160, and third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. Client system 130 may enable a network user at client system 130 to access network 110. Client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable client system 130, social-networking system 160, or third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (i.e., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, third-party system 170 may include a third-party content object provider. A third-party content object provider may include one or more sources of content objects, which may be communicated to client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, ad-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to client system 130. Information may be pushed to client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g., third-party system 170), such as, for example, by setting appropriate privacy settings. Third-party-content-object stores may be used to store content objects received from third parties, such as third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

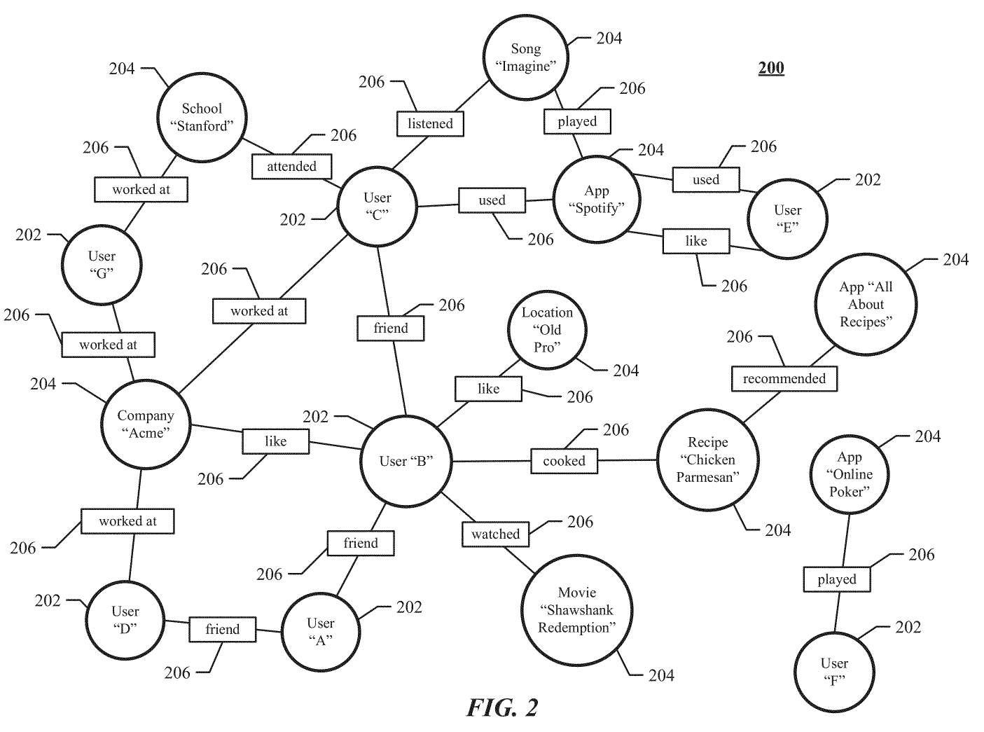

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-networking system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing client system 130 to send to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries

In particular embodiments, social-networking system 160 may receive a query from a user of an online social network hosted by social-networking system 160. A user may submit a query to social-networking system 160 by inputting text into a query field. A user of an online social network may search for information relating to a specific subject matter (e.g., users, concepts, external content or resources) by providing one or more keywords or a short phrase describing the subject matter, often referred to as a “search query,” to a search engine associated with social-networking system 160. The query may be an unstructured text query and may comprise one or more text strings (which may include one or more n-grams). As used herein, an unstructured text query refers to a simple text string inputted by a user. In general, a querying user may input any suitable character string into a query field to search for content on social-networking system 160 that matches the text query. Although this disclosure describes querying social-networking system 160 in a particular manner, this disclosure contemplates querying social-networking system 160 in any suitable manner.

In particular embodiments, social-networking system 160 may receive from a querying/first user (corresponding to a first user node 202) an unstructured text query. As an example and not by way of limitation, a first user may want to search for other users who: (1) are first-degree friends of the first user; and (2) are associated with Stanford University (i.e., the user nodes 202 are connected by an edge 206 to the concept node 204 corresponding to the school “Stanford”). The first user may then enter a text query “friends stanford” into a query field. The text query may, of course, be structured with respect to standard language/grammar rules (e.g. English language grammar). However, the text query will ordinarily be unstructured with respect to social-graph elements. In other words, a simple text query will not ordinarily include embedded references to particular social-graph elements. Thus, as used herein, a structured query refers to a query that contains references to particular social-graph elements, allowing the search engine to search based on the identified elements. Furthermore, the text query may be unstructured with respect to formal query syntax. In other words, a simple text query will not necessarily be in the format of a query command that is directly executable by a search engine (e.g., the text query “friends stanford” could be parsed to form the query command “intersect(school(Stanford University), friends(me))”, which could be executed as a query in a social-graph database). Although this disclosure describes receiving particular queries in a particular manner, this disclosure contemplates receiving any suitable queries in any suitable manner.

In particular embodiments, social-networking system 160 may parse the unstructured text query (also simply referred to as a search query) received from the first user (i.e., the querying user) to identify one or more n-grams. In general, an n-gram is a contiguous sequence of n items from a given sequence of text or speech. The items may be characters, phonemes, syllables, letters, words, base pairs, prefixes, or other identifiable items from the sequence of text or speech. The n-gram may comprise one or more characters of text (letters, numbers, punctuation, etc.) entered by the querying user. Each n-gram may include one or more parts from the text query received from the querying user. In particular embodiments, each n-gram may comprise a character string (e.g., one or more characters of text) entered by the first user. As an example and not by way of limitation, social-networking system 160 may parse the text query “friends stanford” to identify the following n-grams: friends; stanford; friends stanford. Although this disclosure describes parsing particular queries in a particular manner, this disclosure contemplates parsing any suitable queries in any suitable manner.

In particular embodiments, in response to a query from a user, social-networking system 160 may identify a set of conditions associated with an online social network hosted by social-networking system 160 that substantially match the query. As an example and not by way of limitation, the conditions may correspond to one or more constraints associated with the received query. In particular embodiments, social-networking system 160 may search a data store 164 (or, in particular embodiments, a social-graph database) to identify objects substantially matching the conditions. In particular embodiments, a search engine associated with social-networking system 160 may conduct a search based on the conditions using various search algorithms and identify resources, objects, or content (e.g., user-profile pages, content-profile pages, or external resources) that are most likely to be related to the search query. In particular embodiments, a search algorithm may be based on social-graph elements referenced in the search query, terms within the search query, user information associate with the querying user, search history of the querying user, pattern detection, other suitable information related to the query or the user, or any combination thereof. In particular embodiments, the resources, objects, or content identified by social-networking system 160 in response to a search query may be referred to as “search results” or “identified objects” corresponding to the search query. The identified objects may include, for example, social-graph elements (i.e., user nodes 202, concept nodes 204, edges 206), profile pages (or content of profile pages), posts, comments, messages, event listings, user groups, news stories, headlines, instant messages, chat room conversations, emails, advertisements, coupons, pictures, video, music, external webpages, other suitable objects, or any suitable combination thereof. Although this disclosure describes particular types of identified objects, this disclosure contemplates any suitable types of identified objects. In particular embodiments, the search engine may limit its search to resources, objects, or content on the online social network. However, in particular embodiments, the search engine may also search for resources or contents on other sources, such as third-party system 170, the internet or World Wide Web, or other suitable sources. Although this disclosure describes generating particular search results in a particular manner, this disclosure contemplates generating any suitable search results in any suitable manner.

In connection with search queries and conditions being related to query constraints, particular embodiments may utilize one or more systems, components, elements, functions, methods, operations, or steps disclosed in U.S. patent application Ser. No. 13/887,049, filed May 3, 2013, which is incorporated by reference.

In particular embodiments, after identifying a set of objects associated with a query, social-networking system 160 may calculate a plurality of scores for each identified object. In particular embodiments, the identified objects may be scored or ranked based on one or more scoring/ranking algorithms. As an example and not by way of limitation, objects that are more relevant to the search query or to the user may be scored higher than objects that are less relevant. Based on the calculated scores, social-networking system 160 may filter one or more of the identified objects from the set of objects. A filtering process may enhance search quality by removing or filtering out low-scoring or low-quality objects from the set of objects. In particular embodiments, social-networking system 160 may generate one or more search results corresponding to the identified objects remaining in the set of objects, and in response to the query, social-networking system 160 may send one or more of the search results for display to the user.

In particular embodiments, a typeahead process may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays references to the matching profile pages (e.g., a name or photo associated with the page) of the respective user nodes 202 or concept nodes 204, and displays names of matching edges 206 that may connect to the matching user nodes 202 or concept nodes 204, which the user can then click on or otherwise select, thereby confirming the desire to search for the matched user or concept name corresponding to the selected node, or to search for users or concepts connected to the matched users or concepts by the matching edges. Alternatively, the typeahead process may simply auto-populate a field or form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and/or edges, the typeahead process may send a request that informs social-networking system 160 of the user's confirmation of a query containing the matching social-graph elements. In response to the sent request, social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. patent application Ser. No. 12/978265, filed 23 Dec. 2010, U.S. patent application Ser. No. 13/731866, filed 31 Dec. 2012, U.S. patent application Ser. No. 14/24474, filed 3 Apr. 2014, and U.S. patent application Ser. No. 14/304596, filed 13 Jun. 2014, each of which is incorporated by reference.

### Scoring Search Results Using a Conditioned Ranking Model

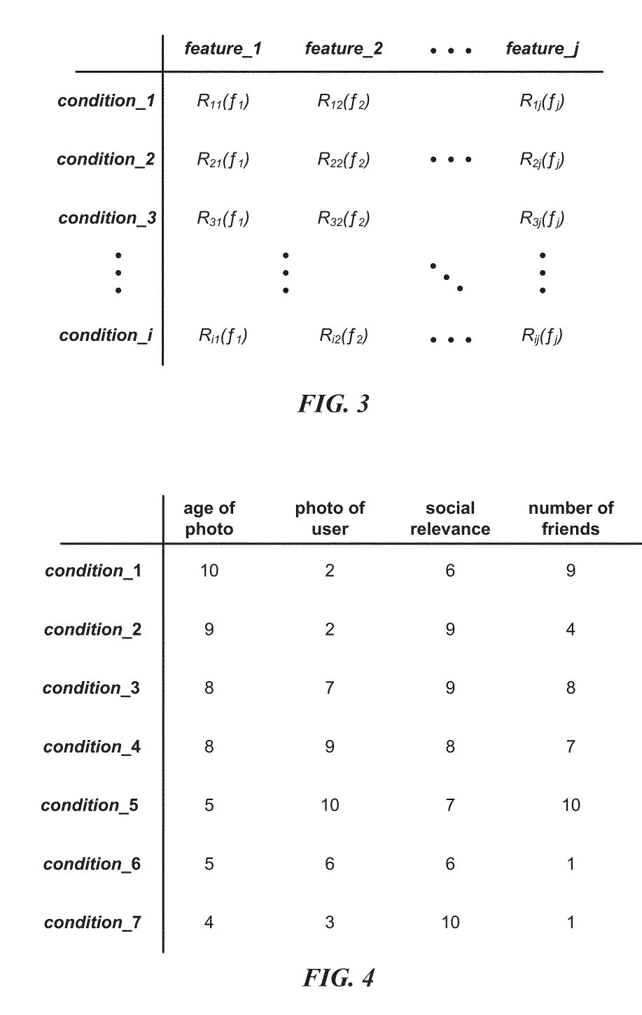

FIG. 3 illustrates an example set of N conditions identified in response to a query. In particular embodiments, in response to a search query, social-networking system 160 may identify any suitable number of search scenarios or conditions that substantially match the query (e.g., i=10, 100, 1000, etc.). Herein, a search scenario may be referred as a condition, or vice-versa, where appropriate. As an example and not by way of limitation, for a search query related to “photos of me in [location],” the conditions that may be associated with the search query are “photos of [user]” and “photos in [location].” In the example of FIG. 3, each condition of condition_1 through condition_i may be applicable to an object identified by social-networking system 160 as likely to be related to a search query. In particular embodiments, social-networking system 160 may score or rank each of the identified conditions based on a variety of factors or criteria, which may be referred to as “features” or “feature vector ( [symbol] ).” Herein, a set of features may be referred as a feature vector ( [symbol] ), or vice-versa, where appropriate. Each search query result may be associated with one or more features. The features may include information about the user, the query, or about the social graph. Furthermore each set of features may be associated with different types of search query content. As an example and not by way of limitation, search query content associated with users of the social-networking system 160 may have features related to demographics data, friends, and followers. As another example and not by way of limitation, search query content associated with photos may have features related to likes, tags, and comments. In particular embodiments, social-networking system 160 may calculate, for each identified condition, a plurality of scores corresponding to the plurality of features, respectively. In FIG. 3, each identified condition of the set of i identified conditions is scored across j features (i.e., feature_1 through feature_j). As an example, condition_1 in FIG. 3 is associated with scores R₁₁(f₁) through R₁ⱼ(fⱼ), and each score is associated with a particular feature. For example, R₁₂(f₂) in FIG. 3 is associated with condition_1 and feature_2. In particular embodiments, each feature may be associated with a particular criteria used to calculate a score for the condition. As an example and not by way of limitation, a score associated with a particular feature may be determined based on age of object, constraint ratio, any suitable combination of one or more of any suitable characteristics associated with the object, social-graph information (such as, for example, degree of separation between social-graph nodes, social-graph affinity, or social relevance, each of which may be its own scoring function), recency, topic relevance, author quality, text similarity, popularity, proximity, a user's search history, or other suitable criteria, or any suitable combination thereof. In particular embodiments, for a set of identified conditions scored with respect to a plurality of features or a feature vector ( [symbol] ), each feature may use a different ranking or scoring function to score objects. The scoring function for a particular feature may depend on the type of feature. As an example and not by way of limitation, a first feature may score objects based on social relevance, while a second feature may score objects based on the age of the object (for example, when it was posted on the online social network). As another example and not by way of limitation, for conditions associated with browsing photos, a first feature may score the identified objects based on whether the photo has a face, a second feature may score the identified objects based on the number of likes for the photo by the user's friends, and a third feature may score the identified objects based on whether the query is for a photo in a pre-determined location. Furthermore, the scoring function for a particular feature may depend on the searching user (for example, age of the user), social information data associated with the searching user, the search history of the user, or the search scenario. As an example and not by way of limitation, for search scenarios, the scoring functions for search queries related to users of the social-networking system 160 and photos may be different. Although this disclosure describes and illustrates particular features or feature vector ( [symbol] ) associated with particular criteria used to determine scores, this disclosure contemplates any suitable features or feature vector ( [symbol] ) associated with any suitable criteria used to determine scores.

In particular embodiments, social-networking system 160 may access a social graph 200 comprising a plurality of nodes and a plurality of edges 206 connecting the nodes, each of the edges 206 between two of the nodes representing a single degree of separation between them. In particular embodiments, a querying user may correspond to a particular user node 202 of a social graph 200, and each and every identified condition may be applicable to the particular user node 202. In particular embodiments, for each identified object, a score corresponding to a particular feature may be based at least in part on social-graph information associated with a querying user and the identified object. As an example and not by way of limitation, a score corresponding to a particular feature may be based at least in part on a degree of separation between the user node 202 of the querying user and a node corresponding to the identified object. Objects that reference social-graph elements that are closer in the social graph 200 to the querying user (i.e., fewer degrees of separation between the element and the querying user's user node 202) may be scored or ranked more highly than objects that are further from the user (i.e., more degrees of separation). In the example of FIG. 2, user nodes 202 of user “A” and user “B” have a single degree of separation, and user nodes 202 of user “B” and user “D” have two degrees of separation. Based on the degrees of separation, a degree-of-separation score for user “B” with respect to user “A” may be higher than a score for user “B” with respect to user “D.” Although this disclosure describes scoring objects based on degree of separation in a particular manner, this disclosure contemplates scoring objects based on degree of separation in any suitable manner. Furthermore, although this disclosure describes and illustrates particular features based on particular social-graph information, this disclosure contemplates any suitable features based on any suitable social-graph information.

In particular embodiments, for each identified condition, a score corresponding to a particular feature may be based at least in part on a social relevance of the identified object to the querying user. Objects that reference social-graph elements that are more closely connected or otherwise relevant to the querying user may be scored more highly than objects that reference social-graph elements that are not as closely connected or are otherwise less relevant to the querying user. As an example and not by way of limitation, the social relevance of a particular node may be based on the number of edges 206 connected to the node, such that an object referencing a node connected by more edges 206 may be scored or ranked higher than another object referencing another node connected by fewer edges 206. As another example and not by way of limitation, the social relevance of a particular edge 206 or edge-type may be based on the frequency of that edge-type being connected to particular nodes. In particular embodiments, identified objects associated with social-graph elements that the querying user has previously accessed, or are relevant to the social-graph elements the querying user has previously accessed, may be more likely to be the target of the querying user's search query. Thus, these identified objects may be scored or ranked more highly. As an example and not by way of limitation, if the querying user has previously visited the “Stanford University” profile page but has never visited the “Stanford, Calif.” profile page, when determining the score or rank for objects referencing these concepts, social-networking system 160 may determine that the object referencing the concept node 204 for “Stanford University” has a relatively high social-relevance score or rank because the querying user has previously accessed the concept node 204 for the school. In particular embodiments, social-networking system 160 may score or rank identified objects based at least in part on advertising sponsorship. An advertiser (such as, for example, the user or administrator of a particular profile page corresponding to a particular node) may sponsor a particular node such that an object associated with that node may be scored or ranked more highly. Although this disclosure describes scoring objects based on social relevance in a particular manner, this disclosure contemplates scoring objects based on social relevance in any suitable manner. Moreover, although this disclosure describes scoring search results based on social-graph information in a particular manner, this disclosure contemplates scoring search results based on social-graph information in any suitable manner.

In connection with scoring identified objects in response to a query, particular embodiments may utilize one or more systems, components, elements, functions, methods, operations, or steps disclosed in U.S. patent application Ser, No. 14/304,596, filed 13 Jun. 2014, which is incorporated by reference.

FIG. 4 illustrates an example set of seven conditions identified in response to a query. In the example of FIG. 4, the query may correspond to browsing photos from vacation. Moreover, the seven identified conditions (condition_1 through condition_7) are scored with respect to a feature vector ( [symbol] ) of four example features (age of photo, photo of user, social relevance, and number of friends). Although this disclosure describes and FIG. 4 illustrates scoring identified conditions with respect to particular types and particular numbers of features or feature vector ( [symbol] ), this disclosure contemplates scoring identified conditions with respect to any suitable types and any suitable numbers of features or feature vector ( [symbol] ). The scores in FIG. 4 are in a range or scoring scale from 0 to 10, where a minimum score of 0 represents little or no match or similarity between an object and a feature and a maximum score of 10 represents a good or perfect match between an object and a feature. In particular embodiments, scores associated with a particular feature may be associated with a particular scoring scale or range. As an example and not by way of limitation, scores may be calculated on a scale or range of 0 to 1, 1 to 5, 0% to 100%, 100 to 1000, or on any suitable scoring scale. In particular embodiments, scores associated with a particular feature may not have any particular or fixed scoring scale or may be scored according to an arbitrary scoring scale. In particular embodiments, scores associated with two different features may have the same scoring scale or may have different scoring scales. In particular embodiments, scores associated with a particular feature may be calculated on an initial scoring scale, and then the scores may be normalized or mapped to another scoring scale. As an example and not by way of limitation, scores for a particular feature may have an initial range of 100 to 500, and those scores may be normalized to a scoring scale with a range of 0 to 10 or 0% to 100%. Although this disclosure describes and FIG. 4 illustrates particular scores associated with particular scoring scales, this disclosure contemplates any suitable scores associated with any suitable scoring scales. In connection with scoring search results, particular embodiments may utilize one or more systems, components, elements, functions, methods, operations, or steps disclosed in U.S. patent application Ser. No. 14/304596, filed 13 Jun. 2014, which is incorporated by reference.

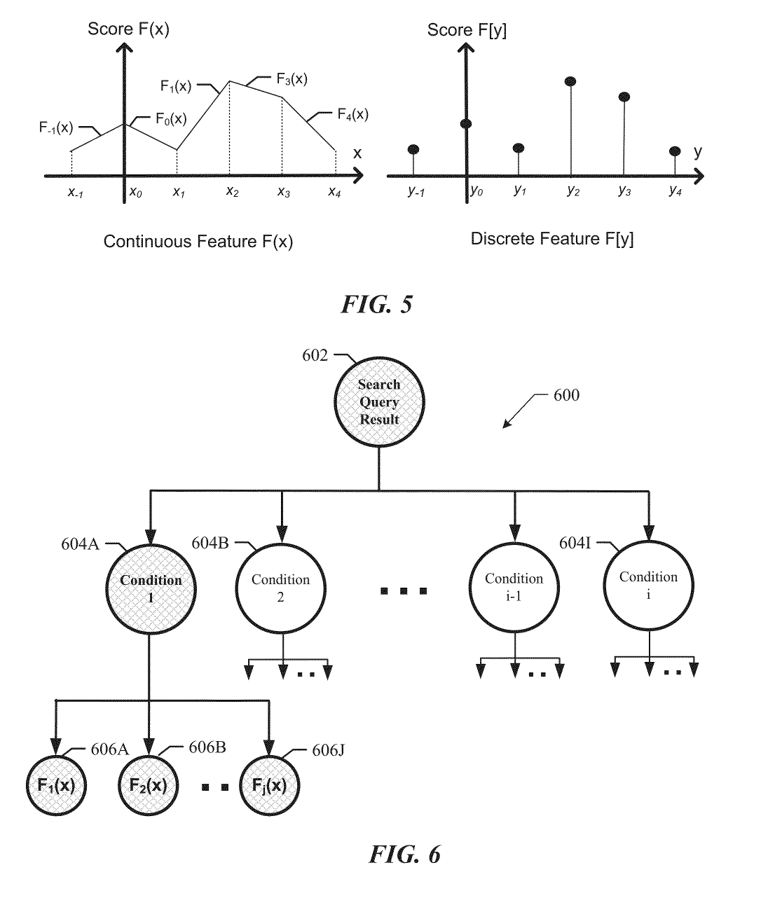

FIG. 5 illustrates example scoring functions. Each scoring function may be adjusted manually or through machine-learning as described below. Furthermore, each scoring function may comprise one or more buckets. Buckets may define the applicable limits between population groups for a particular feature variable. As an example and not by way of limitation, a range between each adjacent bucket's limits constitutes a single population group. In the example of FIG. 5, scoring function F(x) is associated with continuous features while scoring function F[x] is associated with discrete features. As such, scoring function F(x) maps particular feature variable x to particular feature score F(x) associated with a continuous feature. Herein, feature score Rᵢⱼ(fⱼ) may be known as feature score F(x), or vice-versa, where appropriate. Similarly, scoring function F[y] maps particular feature variable y to particular feature score F[y] associated with a discrete feature. Herein, feature score Rᵢⱼ(fⱼ) may be known as feature score F[y], or vice-versa, where appropriate. In particular embodiments, the continuous feature is a feature for which within applicable limits the continuous feature variable x ranges, many feature values are possible. Accordingly, the continuous feature may take on many feature values within applicable limits of feature variable x. As an example and not by way of limitation, feature variable x may be associated with a number of users, a number of mutual friends, a degree of separation between social-graph nodes, an age, an affinity coefficients, a recency, a social relevance, number of clicks, number of “likes”, or number of content queries per day. In particular embodiments, the feature variable x may be an integer. In other particular embodiments, the feature variable x may be a real number. Although this disclosure describes and illustrates particular feature variable associated with a continuous feature, the disclosure contemplates any suitable feature variable associated with any suitable continuous feature in any suitable manner.

In particular embodiments, the discrete feature is a feature for which within applicable limits the discrete feature variable y ranges, a limited number of feature values is possible. In contrast to the continuous feature, the discrete feature may only take on a limited number of feature values within applicable limits of the discrete feature variable y. As an example and not by way of limitation, the discrete feature may be a binary feature (for example, gender, or relationship status). As such, the binary discrete feature variable y may comprise binary feature values such as, for example 1 or 0, yes or no, male or female, or any other suitable binary data. As another example and not by way of limitation, the discrete feature may be categorical (for example, education level). As such, the categorical discrete feature variable y comprises features values that correspond to a limited number of categories. As an example and not by way of limitation, the categorical discrete feature variable y may correspond to locations of the user and its feature values may comprise 0, 1, and 3 where each feature value corresponds to a particular location of the user. Although this disclosure describes and illustrates particular feature variable associated with a discrete feature, the disclosure contemplates any suitable feature variable associated with any suitable discrete feature in any suitable manner.

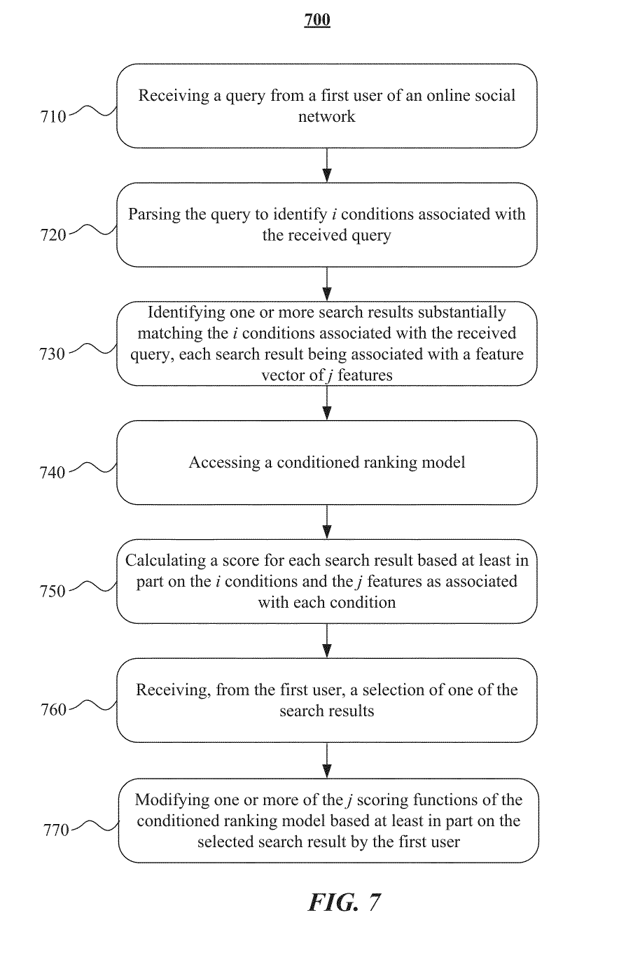

In the example of FIG. 5, scoring function F(x) maps particular feature variable x to particular feature score F(x), as described above. In particular embodiments, scoring function F(x) may be a curve or piecewise function. As such, scoring function F(x) may comprise a plurality of sub-functions where each sub-function corresponds to a particular applicable range or bucket of feature variable x. Buckets may be created for each scoring function F(x). As an example of FIG. 5 and not by way of limitation, feature variable x comprises buckets or intervals x₋₁ to x₀, x₀ to x₁, x₁ to x₂, x₂ to x₃, and x₃ to x₄. Herein, a bucket may be referred as an interval, or vice-versa, where appropriate. In particular embodiments, each interval may comprise equivalent number of feature values. In other particular embodiments, each interval may comprise different number of feature values as pre-determined. As an example and not by way of limitation, the limits x₋₁, x₀, x₁, x₂, x₃, and x₄ may correspond to percentile limits 0%, 20%, 40%, 60%, 80%, and 100% as associated with the feature values of F(x). In the example of FIG. 5, sub-function F₋₁(x) may map feature variable x within interval x₋₁ to x₀ to particular feature score F₋₁(x), sub-function F₀(x) may map feature variable x within interval x₀ to x₁ to particular feature score F₀(x), sub-function F₁(x) may map feature variable x within interval x₁ to x₂ to particular feature score F₁(x), sub-function F₂(x) may map feature variable x within interval x₂ to x₃ to particular feature score F₂(x), and sub-function F₄(x) may map feature variable x within interval x₃ to x₄ to particular feature score F₄(x). In particular embodiments, continuous feature score F(x) may be a real number. In other particular embodiments, continuous feature score F(x) may be an integer. Although this disclosure describes and illustrates particular sub-functions corresponding to particular intervals associated with particular continuous feature, this disclosure contemplates any suitable combinations of one or more of any suitable sub-functions corresponding to the particular intervals associated with the particular continuous feature. As an example of FIG. 5 and not by way of limitation, one or more sub-functions F_{-1, . . . , 4}(x) may be a mathematical linear function. The gradient of each mathematical linear function as described may correspond to a bucket weight. In this case, by changing the weights of the buckets, different mathematic linear functions corresponding to various scoring functions may be obtained across the intervals. In particular embodiments, the scoring function associated with each j feature may be represented by a function vector whose elements correspond to the various bucket weights. In other particular embodiments, social-networking system 160 may even use a machine-learning algorithm (as illustrated and described by FIG. 7) to adjust the bucket weights for each feature. As another example and not by way of limitation, one or more sub-functions F_{-1 . . . , 4}(x) may be a mathematical non-linear function such as for example, a mathematical quadratic function. As yet another example and not by way of limitation, one or more sub-functions F_{-1 , . . . , 4}(x) may be a constant function. Although this disclosure describes and illustrates particular feature variable x of a continuous feature, this disclosure contemplates any suitable feature variable of any suitable continuous feature in any suitable manner. Moreover, although this disclosure describes and illustrates particular scoring function F(x) for particular feature values of particular continuous feature, this disclosure contemplates any suitable scoring function for any suitable feature values of any suitable continuous feature in any suitable manner.

In the example of FIG. 5, scoring function F[y] maps particular discrete feature variable y to particular feature score F[y], as described above. In particular embodiments, scoring function F[y] may be a stepwise function. As such, scoring function F[y] may comprise a plurality of notable, significant, or sudden drops or gaps in feature scores associated with the discrete feature variable y. Alternatively, scoring function F[y] may comprise a plurality of finite constant functions where each constant function F[y] corresponds a particular bucket value or feature value. As an example of FIG. 5 and not by way of limitation, feature variable y comprises feature values y₋₁, y₀, y₁, y₂, y₃, and y₄. In particular embodiments, feature values y₋₁, y₀, y₁, y₂, y₃, and y₄ may correspond to particular categories associated with the discrete feature. Accordingly, scoring function F[y] may map the feature values to corresponding feature scores F[y₋₁], F[y₀], F[y₁], F[y₂], F[y₃], and F[y₄]. As an example and not by way of limitation, the discrete feature may be associated with particular locations of a company and feature values y₋₁, y₀, y₁, y₂, y₃, and y₄ may correspond to the first, second, third, fourth, fifth, and sixth respective addresses of the company. As such, a feature score F[y] may be assigned to each corresponding address of the company. In particular embodiments, discrete feature score F[y] may be a real number. In other particular embodiments, discrete feature score F[y] may be an integer. Although this disclosure describes and illustrates particular constant functions corresponding to particular feature values associated with particular discrete feature, this disclosure contemplates any suitable combinations of one or more of any suitable functions corresponding to the particular feature values associated with the particular discrete feature. Although this disclosure describes and illustrates particular feature variable y of a discrete feature, this disclosure contemplates any suitable feature variable of any suitable discrete feature in any suitable manner. Moreover, although this disclosure describes and illustrates particular scoring function F[y] for particular feature values of particular discrete feature, this disclosure contemplates any suitable scoring function for any suitable feature values of any suitable discrete feature in any suitable manner. As an example and not by way of limitation, as the number of discrete feature values increases, F[y] may approximate any suitable non-linear function within the applicable limits of discrete feature variable y.

FIG. 6 illustrates an example tree data structure for implementing a conditioned ranking model. In particular embodiments, a tree data structure may manage and organize data associated with social graph 200 in one or more data stores 164. Alternatively, tree data structure 600 may abstract representation of social graph 200 in one or more data stores 164. As an example of FIG. 6 and not by way of limitation, tree data structure 600 comprises a root node 602 that stores a score of a search query result, one or more terminal nodes 606 that store features scores for each i condition as described above, and i parent nodes 604 that store condition scores corresponding to the i conditions. Moreover, the search query root node 602 is linked to the i condition parent nodes (a.k.a. i condition child nodes of root node 602), in response to the i identified conditions that substantially match the search query as described and illustrated in FIG. 3. Similarly, each i condition parent node is linked to a feature vector ( [symbol] ) of j feature terminal nodes, in response to the feature vector ( [symbol] ) of j features that are pre-determined by social-networking system 160 to score the particular condition as described and illustrated in FIG. 3. In particular embodiments, the i condition parent nodes are linked the same feature vector ( [symbol] ) of j feature terminal nodes as illustrated by tree data structure 600 of FIG. 6. In other particular embodiments, one or more condition parent nodes are linked to different set of feature terminal nodes. As an example and not by way of limitation, condition 1 parent node may be linked to the j feature terminal nodes as illustrated in FIG. 6, while condition 2 parent node may be linked to a different set of j feature terminal nodes. As another example and not by way of limitation, condition 1 parent node may be linked in the j feature terminal nodes as illustrated in FIG. 6, while condition 2 parent node may be linked to a subset of the j feature nodes. In particular embodiments, the score of the search query result in root node 602 is determined at least in part by the i condition scores as stored in the i condition parent nodes 604 (a.k.a. child nodes of root node 602), while the score of each i condition parent node is determined at least in part by the feature scores as stored in the corresponding feature terminal nodes (a.k.a. child nodes of the condition parent node). Although this disclosure describes and illustrates tree data structure 600 for particular data store associated with social-networking system 160, the disclosure contemplates any suitable tree data structure for any suitable combination of one or more of any suitable data stores associated with any suitable social-networking system in any suitable manner. Although this disclosure describes and illustrates tree data structure 600 for representing particular search query, particular conditions, and particular features in an abstract manner, the disclosure contemplates any suitable combination of one or more of any suitable tree data structures for representing any suitable search query, any suitable combinations of one or more of any suitable conditions, and any suitable combinations of one or more of any suitable features in any suitable manner. Moreover, although this disclosure describes and illustrates tree data structure 600 for storing scores of search query results, scores of conditions associated with the search query, and scores of features associated with the conditions, this disclosure contemplates any suitable tree data structure for storing scores of any suitable search query results, scores of any suitable conditions, and scores of any suitable features in any suitable manner.

### Generating and Sending Search Results

In particular embodiments, social-networking system 160 may generate one or more search query results corresponding to one or more of the identified conditions remaining in the set of conditions, respectively, each search query result including a reference to a corresponding identified object. As an example of FIG. 6 and not by way of limitation, social-networking system 160 may form a tree data structure 600 in response to a search query result generated by social-networking system 160. Root node 602 may be formed corresponding to the search query result and a plurality of child nodes 604A-I corresponding to i conditions may be formed and linked to the root node 602. In particular embodiments, the i condition nodes 604A-I may be formed at one or more levels. Furthermore, j terminal nodes 606A-J may be formed and linked to each condition parent node 604. In the example of FIG. 6, each set of j terminal nodes 608A-J corresponds to an equivalent feature vector ( [symbol] ) of j features.

The search query results can be sorted in any suitable order (e.g., chronologically or by a ranking score) and then presented to the user. The search query results (e.g., the identified nodes or their corresponding profile pages) may be scored (or ranked) and presented to the user according to their relative degrees of relevance to the search query, as determined by the particular search algorithm used to generate the search query results. The search query results may also be scored and presented to the user according to their relative degree of relevance to the user. The search query results may be scored or ranked based on one or more features (e.g., match to the search query or other query constraints, social-graph affinity, search history, etc.), and the top 5, 10, 20, 50, or any suitable number of results may then be generated as search query results for presentation to the querying user. In particular embodiments, the particular search algorithm used to generate the search query results may comprise one or more ranking functions to map each feature vector ( [symbol] ) of j feature scores to an associated condition score. As an example of FIG. 6 and not by way of limitation, a condition score of each i condition parent node 604 of tree data structure 600 may be determined by adding the j feature scores corresponding to the j feature child nodes 606A-J (a.k.a. terminal nodes) of the particular condition parent node 604. As an example and not by way of limitation, a score for condition_n may be represented by Σ_{jεfeatures}Rₙⱼ(fⱼ) where n=1 . . . i. As another example of FIG. 4 and not by way of limitation, condition score associated with condition_1 is determined by adding the features scores corresponding to features “age of photo”, “photo of user”, “social relevance”, and “number of friends”. As such, the condition score for condition_1 is 27. Similarly, a condition score for condition_7 is 18. In other particular embodiments, the particular search algorithms may comprise a linear ranking algorithm to score and rank each search query result based at least in part on the associated i condition scores corresponding to the i condition child nodes 604A-I of the search query result root node 602. As an example of FIG. 6 and not by way of limitation, a score for each search query result associated with root node 602 may be determined by adding the i condition scores corresponding to the i condition child nodes 604A-I. As an example and not by way of limitation, a score for the search query result may be represented by Σ_{iεconditions} Σ_{jεfeatures} Rᵢⱼ(fⱼ) where Rᵢⱼ (fⱼ) corresponds to a feature score of the j features and i conditions. Thereafter, the plurality of search query results may be ranked based on the scores determined for the corresponding search query results. As another example of FIG. 4 and not by way of limitation, a score for a search query result may be determined by adding the seven conditions scores corresponding to conditions 1-7 (i.e., 183). In particular embodiments, social-networking system 160 may only send search query results having a score/rank over a particular threshold score/rank. As an example and not by way of limitation, social-networking system 160 may only send the top ten results back to the querying user in response to a particular search query. Although this disclosure describes generating particular search query results in a particular manner, this disclosure contemplates generating any suitable search query results in any suitable manner.

In particular embodiments, social-networking system 160 may send, responsive to the query, one or more search query results for display to the querying user. The search query results may be sent to the user, for example, in the form of a list of links on a search-results webpage, each link being associated with a different webpage that contains some of the identified resources or content. In particular embodiments, each link in the search query results may be in the form of a Uniform Resource Locator (URL) that specifies where the corresponding webpage is located and the mechanism for retrieving it. Social-networking system 160 may then send the search-results webpage to the web browser 132 on the user's client system 130. The user may then click on the URL links or otherwise select the content from the search-results webpage to access the content from social-networking system 160 or from an external system (such as, for example, third-party system 170), as appropriate. In particular embodiments, each search query result may include a link to a profile page and a description or summary of the profile page (or the node corresponding to that page). The search query results may be presented and sent to the querying user as a search-results page. When generating the search query results, social-networking system 160 may generate and send to the querying user one or more snippets for each search query result, where the snippets are contextual information about the target of the search query result (i.e., contextual information about the social-graph entity, profile page, or other content corresponding to the particular search query result). Although this disclosure describes sending particular search query results in a particular manner, this disclosure contemplates sending any suitable search query results in any suitable manner.

### Training the Conditioned Ranking Model

FIG. 7 illustrates an example method 700 for training scoring functions. The method may begin at step 710, where social-networking system 160 may receive a query from a first user of an online social network hosted by social-networking system 160. The query may be received via web-browser 132 of client system 130. In particular embodiments, social-networking system 160 may access a social graph 200 comprising a plurality of nodes (e.g., user nodes 202 or concept nodes 204) and a plurality of edges 206 connecting the nodes. Each edge between two nodes may represent a single degree of separation between them. The nodes may comprise a first node (e.g., a first user node 202) corresponding to the first user associated with the online social network. The nodes may also comprise a plurality of second nodes that each corresponds to an object associated with the online social network. At step 720, social-networking system 160 may parse the received query to identify a set of i conditions associated with the online social network that substantially match the received query. In particular embodiments, the set of i conditions may be manually pre-determined. In other particular embodiments, the set of i conditions may be pre-determined by pattern-mining algorithms. At step 730, social-networking system 160 may generate one or more search query results substantially matching the i identified conditions, respectively. In particular embodiments, each search query result may comprise a reference to a corresponding identified object. Furthermore, each search query result may be associated with a pre-determined feature vector ( [symbol] ) of j features. At step 740, social-networking system 160 may access a conditioned ranking model (CRM) associated with each search query result to retrieve the feature scores corresponding to each i condition. In particular embodiments, the CRM may be associated with tree data structure 600 as described above. In other particular embodiments, the CRM may include a linear ranking algorithm to determine a rank of each search query result. At step 750, social-networking system 160 may calculate a score for each search result based at least in part on the i conditions and the j features as associated with each i condition. In particular embodiments, the score for each search result may be calculated based at least in part on the i condition scores and the j feature scores as associated with each i condition. As an example of FIG. 6 and not by way of limitation, the score for each search result may be calculated by adding the individual i×j feature scores corresponding to the i×j feature terminal nodes of tree data structure 200. In particular embodiments, one or more CRMs corresponding to the one or more search query results may be stored in one or more data stores 164 within the social-networking system 160. At step 760, social-networking system 160 may present one or more scored search query results, responsive to the query, to the first user via web-browser 132 and receive a selection of one of the scored search query results from the first user. In particular embodiments, the first user may select one of the scored search query results by performing an interactive action with the selected scored search query result. As an example and not by way of limitation, the interactive action may be a click, a like, or a comment. In other particular embodiments, social-networking system 160 may assign label to each interacted search query result, each non-selected but presented search query result, and each non-presented search query result. As an example and not by way of limitation, each interacted search query result may be assigned a label of 1, each non-interacted but presented search query result may be assigned −1, and each non-presented search query result may be assigned −1. In particular embodiments, the labels may be stored a front-end of social-networking system 160. At step 770, social-networking system 160 may adjust one or more of the j scoring functions of the CRM by comparing the selected scored search query result with the j features for each i condition of the CRM. In particular embodiments, social-networking system 160 may adjust one or more of the j scoring functions of the CRM by comparing the labels corresponding to the selected search query results and the j feature scores of the CRMs associated with the selected search query results. In other particular embodiments, the adjustment may be performed manually or by a machine learning algorithm. As an example and not by way of limitation, the machine learning algorithm may comprise stochastic gradient descent (SGD) optimization method. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for training scoring functions in response to a query including the particular steps of the method of FIG. 7, this disclosure contemplates any suitable method for training scoring functions in response to any suitable query including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

In particular embodiments, social-networking system 160 may train the linear rank algorithm. As an example and not by way of limitation, each identified search query result may be ranked by social-networking system 160, as described above. In particular embodiments, each scored search query result may be ranked according to the linear ranking algorithm as described above. Social-networking system 160 may present a pre-determined portion of the ranked search query results to the first user via web-browser 132. As an example and not by way of limitation, the entire ranked search query results may be presented to the first user in a particular order as determined by the respective ranks of the search query results. As another example and not by way of limitation, the top 10% of ranked search query results may be presented to the first user. In particular embodiments, social-networking system 160 may assign a label to each interacted ranked search query result, each non-selected but presented ranked search query result, and each non-presented ranked search query result as described above. As an example and not by way of limitation, each interacted ranked search query result may be assigned a label of 1, each non-interacted but presented ranked search query result may be assigned −1, and each non-presented ranked search query result may be assigned −1. In particular embodiments, social-networking system 160 may adjust the linear ranking algorithm by comparing the selected ranked search query result by the first user with the individual ranks of the identified search query results. As an example and not by way of limitation, the adjustment may be based on any suitable combination of one or more of a suitable pointwise ranking algorithm, a suitable pairwise ranking algorithm, or a suitable listwise ranking algorithm. Although this disclosure describes and illustrates an example method for training linear ranking algorithm in response to a query, this disclosure contemplates any suitable method for training any suitable linear ranking algorithm in response to any suitable query in any suitable manner. Furthermore, although this disclosure describes and illustrates particular components, devices, or systems carrying out particular steps of training a linear ranking algorithm in response to a query, this disclosure contemplates any suitable combination of any suitable components, devices, or systems carrying out any suitable steps of training the linear ranking algorithm in response to any suitable query.

### Systems and Methods

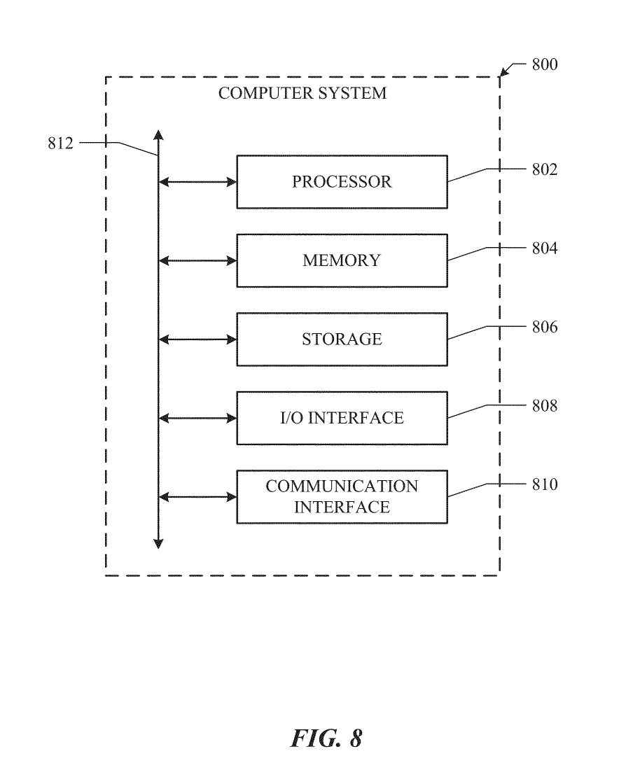

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more computing devices:
receiving a query from a first user;
parsing the received query to identify i conditions associated with the received query;
identifying one or more search results substantially matching the i conditions associated with the received query, each search result being associated with a feature vector of j features;
accessing a conditioned ranking model, wherein the conditioned ranking model comprises:
for each i condition, j scoring functions corresponding to j features of the feature vector associated with each search result; and
a ranking algorithm for determining a rank of each search result;
calculating a score for each search result based at least in part on the i conditions and the j features as associated with each i condition;
receiving, from the first user, a selection of one of the search results; and
modifying one or more of the j scoring functions of the conditioned ranking model based at least in part on the selected search result by the first user.

2. The method of claim 1, wherein i and j are non-zero positive integers.

3. The method of claim 1, wherein the i conditions comprise one or more query constraints associated with the received query.

4. The method of claim 1, wherein the conditioned ranking model is implemented by a tree data structure.

5. The method of claim 4, wherein the tree data structure comprises:
the i conditions forming one or more levels of condition parent nodes; and
each feature vector of j features forming j terminal nodes, wherein:
the j terminal nodes are sibling nodes to an associated condition parent node;
each j terminal node stores a feature score for an associated feature, the feature score being determined at least by a scoring function of the associated feature.

6. The method of claim 5, wherein each condition parent node stores a condition score for an associated condition of the received query, the condition score being determined at least by the feature scores of its associated j sibling terminal nodes.

7. The method of claim 5, where a root node of the conditioned ranking model stores a score of a search result associated with the received query.

8. The method of claim 1, wherein at least one of the scoring function is a piecewise function.

9. The method of claim 8, wherein the piecewise function of a scoring function is associated with a continuous feature.

10. The method of claim 1, wherein at least one of the scoring functions is a step function associated with a discrete feature.

11. The method of claim 1, wherein each scoring function is determined at least in part by the associated condition of the received query and the first user.

12. The method of claim 1, wherein the score is calculated using the ranking algorithm, and wherein the ranking algorithm is a linear ranking algorithm.

13. The method of claim 1, wherein the score for a search result is calculated at least by Σₙ₌₁ⁱ Σₘ₌₁^{j} scoreₙ(m) where scoreₙ(m) corresponds to an output of a scoring function associated with a m^{th} feature and a n^{th} condition.

14. The method of claim 1, wherein the ranking algorithm determines a rank for a search result based at least in part on the calculated score for the search result.

15. The method of claim 1, prior to receiving the selection of one of the search results from the first user, further comprising:
ranking the scored search results; and
presenting, to the first user, at least a pre-determined portion of the search results as ranked.

16. The method of claim 15, further comprising:
comparing the ranks of the scored search results with the selected search result by the first user; and
adjusting the ranking algorithm based at least in part on a result of the comparison, wherein the adjustment is performed pointwise, pairwise, or listwise.

17. The method of claim 1, wherein receiving the selection of one of the search results from the first user comprises determining an interaction associated with the selected search result, wherein the interaction is a click, a like, or a comment.

18. The method of claim 1, wherein modifying the conditioned ranking model comprises:
comparing outputs of the scoring functions with the selected search results by the first user; and
adjusting one or more of the j scoring functions based at least in part on a result of the comparison, wherein the adjustment is performed manually or by a machine learning algorithm.

19. One or more computer-readable non-transitory storage media embodying software that is operable when executed to:
receive a query from a first user;
parse the received query to identify i conditions associated with the received query;
identify one or more search results substantially matching the i conditions associated with the received query, each search result being associated with the a feature vector of j features;
access a conditioned ranking model , wherein the conditioned ranking model comprises:
for each i condition, j scoring functions corresponding to j features of the feature vector associated with each search result; and
a ranking algorithm for determining a rank of each search result;
calculate a score for each search result based at least in part on the i conditions and the j features as associated with each i condition;
receive, from the first user, a selection of one of the search results; and
modify one or more of the j scoring functions of the conditioned ranking model based at least in part on the selected search result by the first user.

20. A system comprising: one or more processors; and a memory coupled to the processors comprising instructions executable by the processors, the processors operable when executing the instructions to:
receive a query from a first user;
parse the received query to identify i conditions associated with the received query;
identify one or more search results substantially matching the i conditions associated with the received query, each search result being associated with the a feature vector of j features;
access a conditioned ranking model , wherein the conditioned ranking model comprises:
for each i condition, j scoring functions corresponding to j features of the feature vector associated with each search result; and
a ranking algorithm for determining a rank of each search result;
calculate a score for each search result based at least in part on the i conditions and the j features as associated with each i condition;
receive, from the first user, a selection of one of the search results; and
modify one or more of the j scoring functions of the conditioned ranking model based at least in part on the selected search result by the first user.
